(19) United States
(12) Patent Application Publication
(10) Pub. No.: US 2004/0193457 A1
(43) Pub. Date: Sep. 30, 2004

(54) Travel cost management system

(75) Inventor: Michael D. Shogren, Minneapolis, MN (US)

Correspondence Address: ROPES & GRAY LLP, ONE INTERNATIONAL PLACE, BOSTON, MA, 02110-2624, US

(73) Assignee: Sapient Corporation, Cambridge, MA

(21) Appl. No.: 10/403,933

(22) Filed: Mar. 28, 2003

(51) Int. Cl. G06F 17/60

(52) U.S. Cl. 705/5

(57) ABSTRACT

A system for booking travel services establishes booking costs based upon a percentage of users in a customer organization that employ self-service booking tools. By bundling call center services from different service providers, an intermediary can offer an aggregate price to a corporate customer that is explicitly tied to the percentage of self-service booking by corporate members. This system advantageously permits a buyer of travel services to quantify the savings from using low-cost, self-service tools, while ensuring that self-service and full service tickets are obtained at a competitive cost.

### BACKGROUND OF THE INVENTION

For years businesses have sought to address the problems of managing and reducing the cost of travel. A number of approaches to this problem have focused on finding the lowest fare for a specified travel itinerary. For example, U.S. Pat. No. 6,295,521 discloses a system that searches for “pricing solutions” to a user-specified origin and destination. U.S. Pat. No. 6,304,850 discloses a system that will autonomously search for and locate tickets meeting user criteria, such as a target price, and then book any tickets meeting the criteria for a sufficient interval for the user to pay for the ticket. U.S. Pat. No. 5,897,620 discloses a system in which tickets are sold at discounted rates for unspecified flight times, leaving the airline that issued the ticket free to manage flight capacity by allocating the ticket to a number of different available flights. While these systems address fares, they do not address the associated costs of booking and fulfilling a ticket.

Other patents disclose techniques for managing travel itineraries across a corporate entity. For example, U.S. Pat. No. 5,832,451 discloses a system in which individual and corporate data is stored by a travel service in a local database for use in travel planning. U.S. Pat. No. 5,570,283 discloses a system in which airline reservation systems, travel agents, and corporate customers are interconnected so that untrained, corporate users can have convenient access to travel planning resources while travel arrangements may be stored for management review. U.S. Pat. No. 6,442,526 discloses a system for tracking and managing expenses that are associated with travel. While these systems may increase the convenience of booking travel reservations for corporate personnel and facilitate management oversight, they still do not address booking and fulfillment costs.

Agency and booking fees for travel reservations, including air, hotel, and car rentals, have received increased attention recently as an area where further savings might be realized by corporate travel customers. However, no system has been proposed that adequately addresses the competing interests and pricing structures of the businesses that sell services into this space.

The emergence in the leisure space of low-cost distribution channels like the online agencies (e.g., Expedia, Travelocity and Orbitz) have created demand for online corporate booking tools, with the expectation that they would also lower transaction costs. Large corporate customers are trying to conduct more travel reservation and payment business online, and it has been estimated that 90% of the corporations with the 100 largest travel budgets have contracted for use of an online booking tool.

Since corporate customers are demanding that agencies show lower cost structures for online originated tickets, the agencies that provide travel booking services to corporate customers have started to offer a new pricing model nominally designed to offer some of the advantages of online booking. In one typical example, they may employ a three-tier pricing model that includes three types of tickets: “touchless”, “lightly managed”, and “full service”. A touchless ticket is a self-service (i.e., online) originated ticket that is subsequently fulfilled by the agency without call center interaction. A lightly managed ticket begins with a self-service tool, but is followed by a phone call or phone calls to a customer service agent. However, a full service ticket originates with a call to a call center. Full service tickets are the most costly alternative in the three-tier pricing model, on the theory that they require the greatest amount of call center support from the agency. This model permits full-service travel agencies to present a low price for online tickets to corporate customers, while recouping costs by charging for each subsequent call to the call center on those tickets.

Agencies are still built around their call center infrastructure. They sell call center services, and seek competitive differentiation in service offerings. They generate revenue based upon the number of call center minutes used, or based upon the number of individual agents required to service a customer. The agencies have little incentive to promote the reduced cost of online booking. Rather, they are best served by promoting the advantages of a full service call center. These agencies may even contract with a third-party online booking provider to manage their own booking, and they have attempted to offer mixed products of various types to corporate customers. However, they continue to protect and promote the revenue from their core business of call center services.

Thus the tiered pricing models developed by the agencies reflect their desire to track internal costs and assure payment for their agents. These models have not lead to high levels of adoption of the low-priced, online tools, and often result in similar, if not higher, overall costs of transactions to the customer who is the end user. In the current market, the agencies' focus on repatriating their internal costs has resulted in pricing structures that bear no relationship to customers' desire to reduce travel costs through adoption of self-service booking tools.

There remains a need for a corporate travel system that provides incentives for corporate personnel to adopt self-service booking tools.

### SUMMARY OF THE INVENTION

A system for booking travel services establishes booking costs based upon a percentage of users in a customer organization that employ self-service booking tools. By bundling call center services from different service providers, an intermediary can offer an aggregate price to a corporate customer that is explicitly tied to the percentage of self-service booking by corporate members. This system advantageously permits a buyer of travel services to quantify the savings from using low-cost, self-service tools, while ensuring that self-service and full service tickets are obtained at a competitive cost.

### BRIEF DESCRIPTION OF THE DRAWINGS

The following figures depict certain illustrative embodiments of the invention in which like reference numerals refer to like elements:

FIG. 1 is a block diagram depicting users of travel reservation systems in a network environment;

FIG. 2 is a flowchart of a process for making travel arrangements; and

FIG. 3 shows a price structure that may be used for booking travel reservations.

### DETAILED DESCRIPTION OF CERTAIN ILLUSTRATED EMBODIMENTS

To provide an overall understanding of the invention, certain illustrative embodiments will now be described, including a system for offering travel services to a corporate customer with a booking cost that is explicitly tied to a percentage of corporate members using online booking tools. However, it will be understood that the methods and systems described herein can be suitably adapted to any group sharing travel reservation services, such as a non-profit organization, educational institution, social club, or government body. Further, while it should be clear that the systems described herein may be applied to a number of travel-related purchases, such as hotel reservations, car rentals, rail reservations, or cruise reservations, it should also be appreciated that the system may be used in other environments where aggregate pricing of different, but related, services might be employed to tie pricing to beneficial customer behavior. These and other applications of the systems described herein are intended to fall within the scope of the invention.

As used herein, terms such as “online booking” and “self-service booking” are intended to refer to booking of travel services using one or more electronic tools without intervention by a live operator. As used herein, terms such as “online booking rate”, “self-service booking rate”, and “adoption rate” are intended to refer to an aggregate rate of the use of such tools by purchasers of travel services that are associated with an identifiable entity.

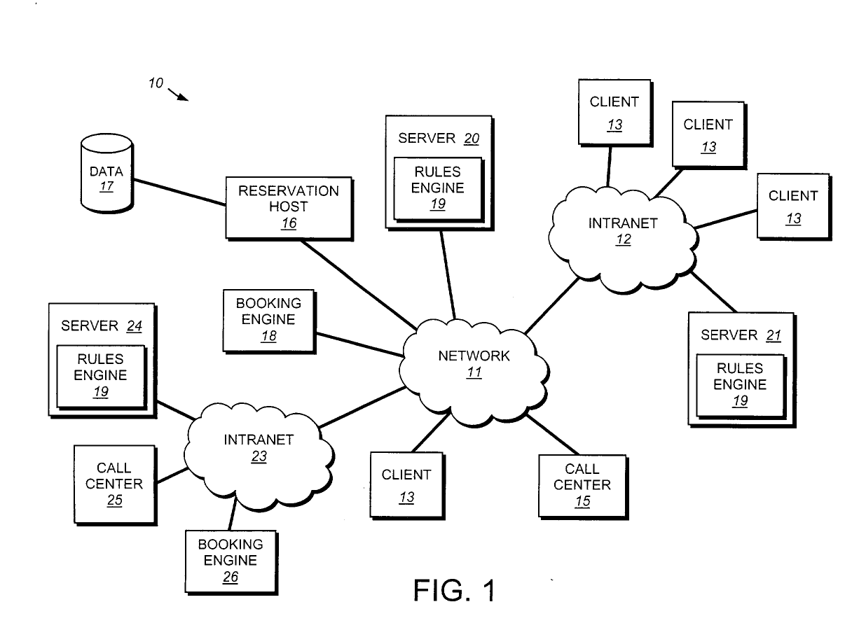

FIG. 1 is a block diagram depicting users of travel reservation systems in a network environment. The network environment 10 may include a network 11, an intranet 12 connected to the network 11 and serving a corporation 19, one or more clients 13 that are operated by customers belonging to the entity 19, one or more call centers 15, one or more reservation hosts 16, each having a database 17, one or more booking engines 18, a remote server 20, and a local server 21, and a remote server intranet 23 with a networked remote server 24, a call center 25, and a booking engine 26. It should be understood that any number of clients 13, call centers 15, reservation hosts 16, booking engines, and servers 20, 21 could participate in the network environment.

The network 11 may include, for example, the Internet and/or any other networks or network of networks suitable for interconnecting the entities as described herein. The World Wide Web may provide a system for interconnecting clients 13 and other entities Internet 11.

The intranet 12 may be a local area network, a corporate area network, a campus area network, or some other network that connects users within a corporation or other entity. The intranet 12 may interconnect clients 13 through a hub (in, for example, a peer network) or a local area network server (in, for example, a client-server network). The intranet may be connected to the network 11 through a gateway, which provides security to the intranet 12 and ensures operating compatibility between the intranet 12 and the network 11. Any data network may be used as the network 11 and the intranet 12. The intranet 12 may include a virtual private network that securely connects clients 13 over one or more public or private networks.

The clients 13 may be computers or other network devices operated by employees of a corporation 19 sharing the intranet 12, or members of some other entity 19, such as an educational institution, an association, a club, a government entity, or other group of affiliated individuals sharing the intranet 12. It will be appreciated that one or more clients 13 operated by a user associated with the entity 19 may connect to the intranet 12 through the network 11.

An exemplary client 13 includes the conventional components of a client system, such as a processor, a memory (e.g. RAM), a bus which couples the processor and the memory, a mass storage device (e.g. a magnetic hard disk or an optical storage disk) coupled to the processor and the memory through an I/O controller, and a network interface coupled to the processor and the memory, such as modem, digital subscriber line (“DSL”) card, cable modem, network interface card, wireless network card, or other interface device capable of wired, fiber optic, or wireless data communications. One example of such a client 13 is a personal computer equipped with an operating system such as Microsoft Windows 2000, Unix, Linux, and Linux variants, along with software support for Internet communication protocols. The personal computer may also include a browser program, such as Microsoft Internet Explorer or Netscape Navigator, to provide a user interface for access to the Internet 11. Although the personal computer is a typical client 13, the client 13 may also be a workstation, mobile computer, Web phone, television set-top box, interactive kiosk, personal digital assistant, or other device capable of communicating over the Internet 11. As used herein, the term “client” is intended to refer to any of the above-described clients 13, as well as proprietary network clients designed specifically for the travel reservation booking systems described herein, and the term “browser” is intended to refer to any of the above browser programs or other software or firmware providing a user interface for navigating the Internet 11 and/or communicating with other entities of the travel booking systems.

The call center 15 may be a full service travel agency with agents who handle incoming calls over a telephone network (not shown) concerning travel reservations. Agents at the call center 15 may access the reservation host 16 and the booking engine 18 to make, change, or cancel travel reservations, or to provide information to a caller. The agents may also employ electronic mail or other communication channels for communicating with customers of the call center, such as users of the clients 13. Typically, the call center 15 will provide fulfillment services, the process by which a ticket in paper or electronic form is delivered to a customer, even when a ticket is booked through another channel, such as the booking engine 18. However, the call center 15 may instead only be used for call center and customer care services, with ticket fulfillment being provided by another entity that specializes in ticket processing services.

The reservation host 16 provides a front end for the database 17 of ticket information. The host 16 may respond to requests for fare information, and receive requests to book reservations. The reservation host 16 may provide ticket information for a single airline, or may aggregate ticket information for a number of different airlines to provide more schedule and price options to users of the host 16. SABRE™ is an example of a well-known reservation host 16, also known as a Computer Reservation System (“CRS”).

The booking engine 18 provides an interface for requesting ticket information and for booking reservations through the network 11. The booking engine 18 may share fare and availability information with the reservation host 16 in a number of manners to ensure that customers are booked to flights with available seating. The booking engine 18 may be used by agents at the call center 15, or may be accessed directly by end users, such as users at the clients 13. In either case, a financial transaction server (not shown) may be accessed to authorize credit card payment or other payment for travel reservations. As noted above, ticket fulfillment will typically not be provided by the booking engine 18. Rather, some other source such as the call center 15, a ticket processing service, or an airline issuing the ticket will fulfill the ticket by delivering the reservation to a customer.

The remote server 20, the local server 21, or the remote networked server 24 may provide booking and fulfillment services to users associated with the entity 19. In the following discussion, the local server 21 is described. However it will be appreciated that either the local server 21 or the remote server 20, or both, may be used, depending on whether the clients 13 access the server 20, 21 locally through the intranet 12 or remotely through the network 11. Each server 20, 21, 24 should be understood to include a rules engine 19 for applying rules and pricing schemes to booking requests entered- according to the systems described herein. The pricing schemes employed by these servers 20, 21 are described in greater detail below.

An exemplary server 21 includes a processor, a memory (e.g. RAM), a bus which couples the processor and the memory, a mass storage device (e.g. a magnetic or optical disk) coupled to the processor and the memory through an I/O controller, and a network interface coupled to the processor and the memory. Servers may be clustered together to handle more client traffic, and may include separate servers for different functions such as a database server, a file server, an application server, and a Web presentation server. Such servers may further include one or more mass storage devices such as a disk farm or a redundant array of independent disk (“RAID”) system for additional storage and data integrity. Read-only devices, such as compact disk drives and digital versatile disk drives, may also be connected to the servers. Suitable servers and mass storage devices are manufactured by, for example, Compaq, IBM, and Sun Microsystems. As used herein, the term “server” is intended to refer to any of the above-described servers.

By way of further example, a multi-tier server architecture may be used as the server 21. This architecture may include a presentation server, an application server, and a database server. The presentation server may provide an interface for one or more connections to the network 11, thus permitting more than one of the clients 13 to access the server 21 at the same time. In one embodiment, the presentation server comprises a plurality of enterprise servers, such as the ProLiant Cluster available from Compaq Computer Corp., or a cluster of E250's from Sun MicroSystems running Solaris 2.7. Other suitable servers are known in the art and are described in Jamsa, Internet Programming, Jamsa Press (1995), the teachings of which are herein incorporated by reference. Each server may be, for example, an iPlanet Enterprise Server 4.0 from the Sun/Netscape Alliance. The presentation server may also, for example, use the Microsoft Windows NT operating system, with a “front end” written in Microsoft Active Server Page (“ASP”), or some other programming language or server software capable of integrating ActiveX controls, forms, Visual Basic Scripts, JavaScript, Macromedia Flash Technology multimedia, e-mail, and other functional and multimedia aspects of a page. Typically, the front end includes all text, graphics, and interactive objects within a page, along with templates used for dynamic page creation.

A client 13 accessing an address hosted by the presentation server may receive a page from the presentation server containing text, forms, scripts, active objects, hyperlinks, etc., which may be collectively viewed using a browser. Each page may consist of static content, i.e., an HTML text file and associated objects (*.avi, *.jpg, *.gif, etc.) stored on the presentation server, and may include active content including applets, scripts, and objects such as check boxes, drop-down lists, and the like. A page may be dynamically created in response to a particular client 13 request, including appropriate queries to a database server for particular types of data to be included in a responsive page. It will be appreciated that accessing a page is more complex in practice, and includes, for example, a DNS request from the client 13 to a DNS server, receipt of an IP address by the client 13, formation of a TCP connection with a port at the indicated IP address, transmission of a GET command to the presentation server, dynamic page generation (if required), transmission of an HTML object, fetching additional objects referenced by the HTML object, and so forth.

The application server of a multi-tier architecture may provide the “back-end” functionality of the Web site, and may include connections to the presentation server and the database server. In one embodiment, the presentation server comprises an enterprise server, such as one available from Compaq Computer Corp., running the Microsoft Windows NT operating system, or a cluster of E250's from Sun MicroSystems running Solaris 2.7. The back-end software may be implemented using pre-configured e-commerce software, such as that available from Pandesic, to provide back-end functionality including order processing, billing, inventory management, financial transactions, shipping instructions, and the like. The e-commerce software running on the application server may include a software interface to the database server, as well as a software interface to the front end provided by the presentation server. The application server may also use a Sun/Netscape Alliance Server 4.0. A payment transaction server may also be included to process payments at a Web site using third party services such as Datacash or WorldPay, or may process payments directly using payment server and banking software, along with a communication link to a bank. While the above describes one form of application server that may be used with the systems described herein, other configurations are possible.

The database server may be an enterprise server, such as one available from Compaq Computer Corp., running the Microsoft Windows NT operating system or a cluster of E250's from Sun MicroSystems running Solaris 2.7, along with software components for database management. Suitable databases are provided by, for example, Oracle, Sybase, and Informix. The database server may also include one or more databases, typically embodied in a mass-storage device. The databases may include, for example, information about users belonging to the entity 19, information for authorization financial transactions, travel policies, travel preferences, booked travel reservations, and so forth. In operation, the database management software running on the database server receives properly formatted requests from the presentation server, or the application server. In response, the database management software reads data from, or writes data to, the databases, and generates responsive messages to the requesting server. The database server may also include a File Transfer Protocol (“FTP”) server for providing downloadable files.

A number of suitable interfaces may be provided to users by the local server 21, including a web page accessible by the clients 13. The web page may provide controls for searching schedule, price, and availability information, and for booking flights. The local server 21 may pass user requests to the appropriate booking engine 18 and/or reservation host 16 and present responses to the requesting client 13.

The local server 21 may also coordinate with databases and applications maintained by the entity 19, in order to effectively share information about travel reservations. This may include, for example, sharing booking and other travel information with accounting applications, expense management applications, or other financial applications maintained by the entity 19. Controls may be included within the web page to assist a user with these applications, such as an interface to request reimbursement once a travel reservation is booked. Similarly, a travel policy management application may be integrated with the system to automatically review travel reservations to ensure that they conform to one or more travel policies maintained by the entity 19, or a travel management application may provide for direct review and approval of travel plans by someone within the entity 19 immediately prior to booking. These and other applications may be integrated with the system described herein, and may be provided within the booking web page, or available through links provided within the booking web page. Additionally, the local server 21 may provide a travel portal, available through the intranet 12, or remotely through the network 11 that offers travel planning, reservation booking, and fulfillment features to users.

Generally, the web page may be an HTTP object that includes plain text (ASCII) conforming to the HyperText Markup Language (“HTML”). Other markup languages are known and may be used on appropriately enabled browsers and servers, including the Dynamic HyperText Markup Language (“DHTML”), the Extensible Markup Language (“XML”), the Extensible Hypertext Markup Language (“XHML”), and the Standard Generalized Markup Language (“SGML”).

The web page may contain hyperlinks to other web pages. A browser at a client 13 may display the web page on the screen for the user and the hyperlinks to other web pages may be emphasized in some fashion such that the user can identify and select each hyperlink. To enhance functionality, the server 21 may execute programs associated with web pages using programming or scripting languages, such as Perl, C, C++, or Java. The server 21 may also use server-side scripting languages such as ColdFusion from Macromedia, Inc., or PHP. These programs and languages perform “back-end” functions such as order processing, database management, and content searching. A web page may also include references to small client-side applications, or applets, that are transferred from the server 21 to the client 13 and executed locally by the client 13. Java is one popular example of a programming language used for applets. The text within a Web document may further include (non-displayed) scripts that are executable by an appropriately enabled browser, using a scripting language such as JavaScript or Visual Basic Script. Browsers may further be enhanced with a variety of helper applications to interpret various media including still image formats such as JPEG and GIF, document formats such as PS and PDF, motion picture formats such as AVI and MPEG, and sound formats such as MP3 and MIDI. These media formats, along with a growing variety of proprietary media formats, may be used to enrich a user's interactive and audio-visual experience as each web page is presented through the browser. The term “page” as used herein is intended to refer to the web pages described above, as well as any of the above-described functional or multimedia content associated with the web pages.

As noted above, the server 21 may include a rules engine 19 that provides application logic for booking reservations. This may include, for example, rules applicable to a particular individual that requests a booking, such as cost and levels of accommodation permitted for travel. The rules engine 19 may also include rules applicable to the entire entity, such as corporate discounts. The rules engine 19 may also include a local version of a price schedule used to determine booking costs for a booked travel reservation. It will be appreciated that, while the server 21 provides an interface to a corporate client 13 using the self-service booking tool, the server 21 may also communicate with a booking engine 16, a reservation host 16, and a call center 15 in order to complete booking or for maintenance functions such as updating the pricing schedule.

It should also be appreciated that, while the system 10 may employ a server 21 within the corporate intranet 12 or a remote server 20 connected to the network 11, the server 24 may also interact with the system 10 through its own intranet 23, which may optionally include its own call center 25 and booking engine 26. More generally, it will be appreciated that the rules engine 19 may exist anywhere within the system 10 provided that it can be accessed by the clients 13 and that the rules engine 19 can access other entities such as one of the call centers 15, 25, one of the booking engines 18, 26, and the reservation host 16. It should also be appreciated that the network 11 may include one or more leased lines or other dedicated connections between any of the components of the system 10 described above, such as the call center 15 and the reservation host 16, or the booking engine 18 and the data 17 associated with the reservation host 16.

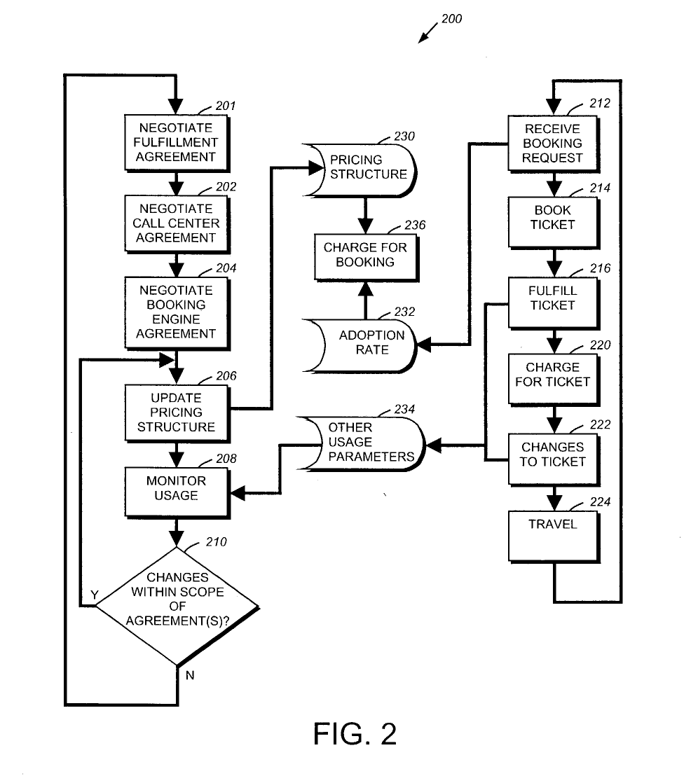

FIG. 2 is a flowchart of a process for making travel arrangements. The process 200 may be included in a travel portal made available, for example, over a corporate network to employs of the corporation, or to some other users associated with an entity. This portal may be presented, for example, as a web page on a server, such as the web pages and servers described above.

It will be appreciated that some steps of the process 200 may be realized in hardware, software, or some combination of these. Some steps of the process 200 may be realized in one or more microprocessors, microcontrollers, embedded microcontrollers, programmable digital signal processors or other programmable device, along with internal and/or external memory such as read-only memory, programmable read-only memory, electronically erasable programmable read-only memory, random access memory, dynamic random access memory, double data rate random access memory, Rambus direct random access memory, flash memory, or any other volatile or non-volatile memory for storing program instructions, program data, and program output or other intermediate or final results. The process 200 may also, or instead, be deployed on an application specific integrated circuit, a programmable gate array, programmable array logic, or any other device that may be configured to process electronic signals.

Any combination of the above circuits and components, whether packaged discretely, as a chip, as a chipset, or as a die, may be suitably adapted to use with the systems described herein. It will further be appreciated that the some steps of the process 200 may be realized as computer executable code created using a structured programming language such as C, an object oriented programming language such as C++, or any other high-level or low-level programming language that may be compiled or interpreted to run on one of the above devices, as well as heterogeneous combinations of processors, processor architectures, or combinations of different hardware and software.

In general, the process 200 involves cooperation of two separate process flows. A first process flow (steps 201-210) establishes the price structure for an entity. A second process flow (steps 212-224) describes the manner in which individual travel reservations are obtained and used by a user associated with the entity. Data elements 230-234 retain data generated by the two process flows, and are ultimately used to determine a charge for booking in step 236. In FIG. 2, data flows horizontally, i.e., from left to right or from right to left, while steps in the process flow vertically from top to bottom.

The first process flow may begin by negotiating a fulfillment agreement with an agency, as shown in step 201. The agreement may specify the manner(s) in which tickets are fulfilled to a purchaser, and may include limitations on fulfillment channels (e.g., maximum number of paper tickets). Deviations from these limitations may alter the fee structure in some deterministic fashion, result in surcharges, or trigger renegotiation of terms of the agreement.

Next, a fee agreement may be negotiated with a call center, as shown in step 202. A call center services vendor may offer a fixed or reduced price per ticket in return for restrictions on services, such as limitations on the number of changes or cancellations to booked reservations and limitations on the number and duration of follow-up phone calls to the call center. Deviations from the limitations may alter the fee structure in some deterministic fashion, result in surcharges, or trigger renegotiation of terms of the agreement. Pricing may also be related, in part, to total call center time used by the entity, or the number of agents required by the call center to service the entity.

As shown in step 204, a fee agreement with a booking engine may be negotiated. Typically, this agreement would not include usage limitations or service restrictions. However, the agreement may provide, for example, for volume discounts on booking costs.

With separately negotiated agreements as described in steps 201-204 above, it is possible for an intermediary to pass the true, aggregate costs of services on to corporate consumers of travel reservation services. This is in marked contrast to existing tiered pricing models, which impose booking costs for each transaction at the time services are used, and may overestimate provider costs in order to ensure a positive return on each reservation serviced. Negotiating each agreement separately may also place the intermediary in the advantageous position of being able to independently select, as appropriate, the most cost-effective provider of each service. It should be appreciated that, consistent with the above description, one supplier may provide more than one of the above services, in which case a bundled service offering may be negotiated collectively.

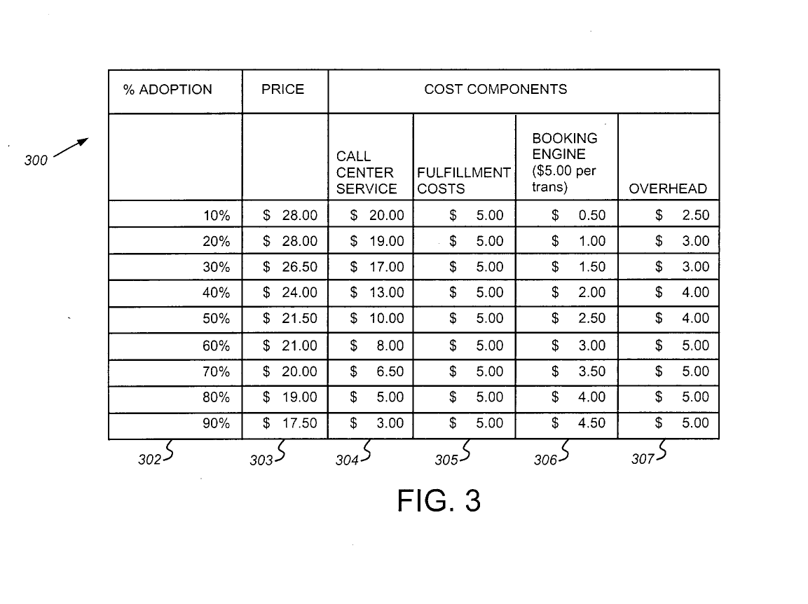

As shown in step 206, a pricing structure may be determined (or updated) for use in an integrated travel service offering. The pricing structure combines the costs negotiated above for individual services with the intermediary's costs, such as administrative costs, overhead, and profit for the intermediary. An offering based upon the pricing structure may then be deployed by a server such as the servers described above, that may offer a travel portal or other web site or web page for use by individuals associated with an entity. The integrated service offering may include direct access to the call center for users who prefer not to book online, or, e.g., users who wish to make modifications to travel arrangements without access to a computer, such as a traveler in an airport, with pricing for all such uses built in to the pricing structure. The pricing structure may be persistently stored, as shown in a pricing structure data structure 230, on the server that provides a rules engine for the travel reservation system, or elsewhere within the system depicted in FIG. 1. An example pricing structure is described in further detail below with reference to FIG. 3.

As shown in step 208, usage of the integrated service offering may be monitored. In general, monitoring may ensure compliance with the agreements described above, such as fulfillment restrictions or ticket changes, and may provide data for an adoption rate used in pricing new bookings. Although monitoring adoption rate is presently depicted as a separate data flow from step 212 to an adoption rate data structure 232, it will be appreciated that this may also be considered to be within usage monitoring as shown in step 208. In certain embodiments, surcharges for certain usage types may be applied according to one or more of the agreements above, such as surcharges for follow-up phone calls, in which case monitoring would also include tracking call center time that is spent servicing fulfilled tickets so that appropriate surcharges can be assessed. If no changes occur in the usage of the travel reservation system that require adjustments to pricing, then the process 200 may continue to monitor usage 208 for further changes.

Data for the monitoring step 208 may be received from a variety of sources. A number of online booking requests may be reported in a message or other data communication by the server that supports the web page. Data concerning full-service booking and fulfillment may be provided in periodic reports from the call center, or may be provided as a continuous or periodic data feed from the call center. When changes are made to a ticket by the call center, these follow-on services may be reported by the call center as a number of calls, a total duration of calls, an average length of call, and so forth. It will be appreciated that monitoring usage as shown in step 208 may occur periodically, such as once per day, once per week, or once per month, or may occur continuously, provided suitable data is provided by the call center. The period for monitoring may be established, for example, by the agreements with the call center and the booking engine.

As shown in step 210, a determination may be made whether changes in usage of the integrated travel reservation offering necessitate changes to in existing agreements. In general, it is expected that adoption rate will vary over time, and the price structure accommodates these variations. However, failure to meet certain pre-conditions (such as the restrictions by call centers noted above) may require renegotiation or repricing of the agreements between an intermediary that provides the combined travel reservation offering and the call center or booking engine used by the intermediary. If changes in usage require renegotiation of agreements, then the process 200 may return to step 202 where new negotiations are undertaken. Even where changes in usage do not necessitate a new agreement, they may cause a change in prices charged by, for example, the call center, that requires the price structure to be updated. In such cases, the process 200 may return to step 206 where the price structure is updated.

Turning now to the second process flow (steps 212-224), the flow may begin when the integrated travel reservation offering, provided, for example, in a web page from the server, receives a booking request from a user associated with the entity, as shown in step 212. The booking request may result from other interactions with the web page, such as searching for available flights, hotels, railroad travel, car rentals, and so forth, or receiving recommendations or other trip planning advice through the web page. The server may support these functions by accessing one or more booking engines or reservation hosts and presenting results to the user through the web page. After reviewing available alternatives, the user may submit a booking request through the web page, which is received and processed by the server.

The following steps refer generally to an online booking procedure. It will be appreciated that the steps may also be conducted through a call center in a conventional manner. In this case, the ticket is booked and fulfilled according to existing call center practices. Whether the booking request is performed online or through a call center, the occurrence of the booking request is used to update the adoption rate 232. In addition, it should be appreciated that certain aspects of the transaction, such as ticket fulfillment (step 216) and ticket changes (step 222) may be monitored for a ticket, whether booked online or through a call center in order to monitor usage in step 208.

As shown in step 214, the ticket (or other reservation) may be booked. This may include a number of interactions between the server and the client (through which a user provides, e.g., name, credit card information, corporate account number). This may also include interactions between the server and, for example, the reservation host, the booking engine, and a financial transaction server. This step results in a ticket being booked for the user, as reflected in one or more records at the appropriate reservation host database(s). In the case of a call center originated ticket, the mechanical aspects of the booking are performed by an agent at the call center, who may operate a computer terminal to communicate with appropriate services and databases to complete the booking.

As shown in step 216, the ticket may be fulfilled. This may include, for example, delivery of electronic ticket information over the network, or delivery of a paper ticket by mail. This may also include quality assurance for the reservation, confirmation and finishing of the reservation in the CRS system.

As shown in step 220, the entity may be charged for the ticket. It should also be appreciated that each ticket typically includes two price components. One component is the underlying price for the ticket or other travel service. This price is passed from the originator (e.g., an airline, hotel, or car rental agency, or other agency acting as a merchant of record) through the call center or booking engine to the user who purchases the ticket. This price may include commissions and/or incentives from the originator to the intermediary, but is paid to the originator. A second component is the booking and fulfillment costs. While the amount of booking and fulfillment costs charged to a user under the pricing structures described herein may be controlled by an intermediary, the underlying cost of the travel service would typically be passed directly to the user. Thus, when a user pays for a ticket, the user pays a first price for the ticket and a second price for any booking or fulfillment costs added by intermediaries. The determination of booking costs is described in more detail below. In certain embodiments, the cost may be determined and assessed immediately, or the cost may be estimated based upon historical data and reconciled on some periodic basis, or omitted completely and charge in the aggregate for the entity on some periodic basis.

As shown in step 222, changes may be made to a ticket after the ticket has been booked and fulfilled 222. This may include, for example, changing a ticket (e.g., to a different time or day) or canceling a ticket. In some cases, changes may be made through an online booking engine. In other cases, changes may be made through a call to the call center, particularly where a purchaser is en route using a purchased ticket. Depending upon the terms agreed to with the service providers (booking engine and call center), changes may be a service included in the initial booking and fulfillment cost, or they may be charged on a per-minute or per-change basis, or some combination of these.

As shown in step 224, a user that purchased one or more travel services may travel using airline tickets, train tickets, hotel reservations, car rental reservations, or any other travel services booked and fulfilled through the systems described herein. The second process flow may return to step 212 where a new booking request may be received. While illustrated as a single, sequential process, it will be appreciated that any number of booking requests 212 may be commenced at any time, and any number of purchasers may make changes 222 or travel 224 at any time. As such, the second process flow (steps 212-224) should not be viewed as a group of discrete, sequential travel events. Rather, it should be viewed as a collection of overlapping, concurrent travel events, that grows and shrinks in volume according to the aggregate travel by users associated with the entity.

As shown in step 236, an entity is charged for booking reservations for travel services. Once a pricing structure 230 has been determined and an adoption rate 232 has been determined, this is a straightforward process of applying the adoption rate 232 to the pricing structure 230 and charging for each ticket booked. Thus an entity is charged for booking according to an aggregate adoption rate of self-service booking tools by users belonging to the entity. As noted throughout the above description, there may also be surcharges where usage by the entity exceeds limits established when negotiating for the services 201, 202, 204. These may be charged along with the charge for booking.

It should also be appreciated that charges for booking in step 236 may take a number of forms. The charges may be determined for aggregate usage over some previous period. In other words, usage and adoption may be tracked for some period, such as a week or a month, and at the end of that period, a charge may be assessed according to an adoption rate during that period. Optionally, each charge may be determined when a ticket is booked according to some historical or dynamically determined adoption rate 232, as discussed below in greater detail. In such a case, total booking cost charges may be adjusted periodically so that the total charge to the entity reflects aggregate usage by users belonging to the entity.

In certain embodiments, the charge for booking may be largely or completely independent of subsequent ticket changes. For example, the intermediary providing the integrated travel service offering may establish a fixed pricing structure based exclusively on adoption rate and offer this to an entity. In effect, the intermediary then assumes the risk of ticket changes and other call center usage exceeding expected usage. Similarly, the intermediary may charge immediately for booking costs according to historical adoption rates, and assume the risk of significant variations in adoption rates for self-service booking tools.

Three data structures may be maintained in the process 200, a pricing structure 230, an adoption rate 232, and other usage parameters 234.

The pricing structure 230 represents the sum of fees negotiated in steps 201-204, along with any general administrative costs, overhead, and profit for the intermediary offering the travel reservation system. An example pricing structure is described in greater detail below with reference to FIG. 3. Surcharges may also be passed to a customer where usage by the entity exceeds negotiated levels of service, such as total call center minutes or number of paper tickets requested.

The adoption rate 232 measures the use of online booking tools by users associated with, or belonging to, the entity. The adoption rate 232 may be expressed as a percentage, ratio, or other proportion of users who book online to the number of users associated with the entity that book travel reservations. Alternatively, an adoption rate may be measured as a ratio of number of reservations booked online to total number of reservations, or dollar value of reservations booked online to total dollars of travel reservations. Other benchmarks for online adoption may be used, provided that they provide an objective, quantitative proxy to online booking behavior by users of the entity. As described above, the adoption rate may be determined periodically for the entity over a reporting period such as daily, weekly, or monthly, or the adoption rate may be dynamically determined with up to date information when a booking request is made. In the latter case, the adoption rate would typically be determined from some fixed time, such as the beginning of a week or month, or as a sliding window of a set number of days or weeks. It will be appreciated that a sliding window will, like a moving average, tend to exhibit less volatility than non-averaged measurements.

While a system that prices booking according to adoption rate is described, it will be appreciated that other parameters may be used instead. For example, where an entity has achieved a desired level of self-service or online booking and realized the savings associated therewith, the entity may desire to price booking according to some other parameter in order to further drive usage of the travel reservation system toward more cost-effective modes. This may include, for example, assessing booking costs according to average call center minutes or adoption of electronic ticketing. Any component of booking costs may thus be similarly used as an independent variable by which an intermediary determines pricing for aggregate booking costs to an entity.

Other usage parameters 234 are also monitored by the system for various purposes. As noted throughout this description, this may include, for example, tracking compliance with service agreements or determining when surcharges might be appropriate for certain usage of travel reservation services by users of the entity. Specific parameters that may be monitored include call center minutes, fulfillment modes, or number of changes to tickets.

It will be appreciated that the order of many of the steps set forth above may vary. For example, charging for a ticket (step 220) may occur before or after the ticket is fulfilled (step 216). As another example, negotiating a booking engine agreement (step 204) may occur before negotiating a call center agreement (step 202). Similarly, the charge for booking 236 may occur at any time independent of the other process steps, and would typically occur on some periodic basis such as weekly, monthly, or quarterly. All such variations consistent with use of the innovative pricing structure and system for booking travel arrangements are intended to fall within the scope of this disclosure.

FIG. 3 shows a price structure that may be used for booking travel reservations. In general, FIG. 3 shows per-ticket costs for booking and fulfilling an airline ticket using the systems described herein. The price structure 300 may carry restrictions on a level of service provided by the call center or the booking engine. For example, the price structure 300 may only apply where, for example, requests for paper tickets are less than ten percent of tickets booked, manual quality control (e.g., for incorrectly entered or recorded data) is required on less than ten percent of tickets, ticket exchanges are below five percent, refunds are below five percent, voids are below five percent, follow-up calls for call-center-originated tickets are less than three in one-hundred with an average of five minutes per call, and follow-up calls for online booked tickets are less than five in one-hundred with an average of five minutes per call. These restrictions are exemplary only, and actual restrictions may be negotiated between an intermediary and a call center, an online booking engine, and a fulfillment service provider. There are a number of approaches for addressing usage that exceeds one or more of these restrictions. For example, a surcharge may be added for each ticket that exceeds one of these restrictions, or a flat surcharge may be applied for any usage that exceeds one of the restrictions. Such a surcharge may vary according to which restriction has been exceeded. As another example, exceeding the restrictions may shift the entire price structure in some defined manner, or may trigger renegotiation of one or more cost components, which may be passed along to an entity using the price structure 300.

The first column shows an adoption rate 302 for an entity. In this example, the adoption rate is expressed as a percentage of travel reservations by users associated with an entity that are booked online. The price structure 300 allows for a full range of adoption rates, so that changes in adoption rate at an entity will not, by itself, require any revisions to the pricing structure. More generally, a price structure may employ any independent, objectively determinable parameter to determine a booking price for a ticket booked by a member of an entity. Thus, as noted above, in other possible embodiments different variables may be employed to provide incentives for desired behavior with respect to booking, fulfillment, and/or call center usage. For example, booking price could be determined according to voids/returns, average minutes per call, or follow-up calls on self-service call center originated tickets. Thus while the adoption rate for self-service tools should be understood as a significant driver of booking cost reduction, in other embodiments of the system described herein, a pricing schedule may assume constant self-service adoption with price established according to some other aspect of aggregate booking and fulfillment behavior by users of the entity.

The second column shows an example of a price 303 that may be applied, in the aggregate, for ticket costs of tickets purchased over some predetermined period. It will be noted that an entity using the systems described herein may benefit from the simple relationship expressed between adoption rate and the price for ticket costs, and may use this relationship to provide incentives for increased adoption of online or self-service booking tools.

The third, forth, and fifth columns 304-306 show cost components of the price 303 charged by the intermediary for each ticket.

The third column shows an example of call center service costs 304 as negotiated in an example agreement between the intermediary and the call center. It will be noted that the costs, on a per-ticket basis, decrease as the adoption rate increases. As adoption rate increases, the call center services (per ticket) decrease toward a minimum charge of one dollar. By contrast, as adoption rate decreases, the call center services increase toward the cost of a full-service booking ($20 in this example) originated through a phone call to the call center. This price may be scaled aggressively based upon the unexpectedly high correlation between initial booking with self-service tools and a reduction in the need for follow-up call center support. That is, by realizing that people who book online tend not to employ call centers even when changing previously booked travel reservations, it has become possible to offer surprisingly steep discounts for entities that have high adoption rates. It is possible to pass these anticipated savings to such an entity within the pricing structure 300.

The fourth column 305 shows fulfillment costs which may be relatively invariant and are considered fixed costs per ticket in this example.

The fifth column shows booking engine costs 306 per ticket. As noted above, a booking engine typically will not provide a significant discount for volume, so the example price structure 300 reflects a fixed cost of five dollars for each ticket booked online. As the adoption rate for online booking decreases, however, a smaller number of tickets incur this fee and the cost per ticket decreases.

While certain cost components 304, 305, 306 are depicted, it will be appreciated that other cost components may also be included in the price structure 300. For example, the intermediary may provide reporting of expenses and other data relating to travel reservations, including aggregate data and one or more standard reports for travel transactions. A significant element of cost reduction for such reporting may be the use of self-service booking tools, which cost reduction may be incorporated into the price structure 300. Similarly, the intermediary may handle expense management functions, or contract to have these functions handled by a third party, and pass the costs along to the entity using the system 10. As another example, the intermediary may manage use of travel vouchers or other pre-authorization schemes for employee travel, and pass costs thereof to the entity in the pricing structure 300.

As shown in the sixth column, the price 303 may also include overhead 307 charged by the intermediary. The overhead 307 may be fixed or variable, with variable overhead being depicted in FIG. 3. The overhead 307 may include, for example general administrative costs, overhead costs, and any profit that may be realized by the intermediary. While it is generally expected that the aggregate of costs and overhead reflected in the price 303 would be less expensive than existing alternatives, it is not required that the price structure 300 be less than or equal to such alternatives at any one or more adoption rates specified in the price structure 300.

The pricing structure 300 may be stored as the pricing structure 230 shown in FIG. 2, and applied within the travel reservation system to determine booking costs for an entity. The manner in which the pricing structure is monitored, measured, and reported to the entity may be agreed to in advance with the provider It should be appreciated that, as noted above, additional surcharges may, in certain cases, be passed through to the entity using the integrated travel reservation offering. The numbers presented in FIG. 3 are intended to illustrate the components of pricing for booking travel reservations and are not intended to reflect prices that might be presently available in the travel industry.

It will be understood by those skilled in the art that airlines, hotel chains and car rental agencies may themselves provide call center support for online purchases of their services, sometimes for a fee. In addition, some travel service providers may provide reservation and booking service free of charge. All such services may be implemented alongside the system described above, and be incorporated into a web page that provides a travel portal. Accordingly, while the invention has been disclosed in connection with the preferred embodiments shown and described in detail, various modifications and improvements thereon will become readily apparent to those skilled in the art. Accordingly, the spirit and scope of the present invention is to be limited only by the following claims.

What is claimed is:

1. A method for booking a travel reservation comprising:
receiving a booking request for a travel reservation from a user associated with an entity;
determining an online booking rate for users associated with the entity, the online booking rate indicative of a percentage of the users associated with the entity that book online;
determining a cost for booking the travel reservation, the cost based upon the online booking rate for users associated with the entity; and
providing the travel reservation to the user at a price that includes the cost for booking the travel reservation and a cost of the travel reservation.

2. The method of claim 1 wherein the cost of booking provides a discount for online booking to the user representative of an anticipated reduction in call center support costs for that user.

3. The method of claim 1 wherein the online booking rate for users associated with the entity is determined over a period of time, the cost for booking the travel reservation being assessed for each travel reservation secured during the period of time.

4. The method of claim 1 wherein the online booking rate for users associated with the entity is monitored and determined dynamically.

5. The method of claim 1 further comprising providing a travel portal available through a corporate intranet maintained by the entity, the travel portal providing travel planning, reservation booking, and fulfillment features to users.

6. The method of claim 1 further comprising monitoring travel arrangements of users associated with the entity and ensuring compliance of the travel arrangements with one or more travel policies of the entity.

7. The method of claim 1 further comprising monitoring travel arrangements of users associated with the entity and providing reimbursement to one or more of the users for travel reservations.

8. The method of claim 1 wherein the travel reservation includes at least one of an airplane reservation, a hotel reservation, a rail reservation, or a car rental reservation.

9. The method of claim 1 wherein the entity is at least one of a corporation, a government entity, a non-profit organization, an educational institution, or an association.

10. The method of claim 1 wherein receiving a booking request further comprises receiving at least one of an online booking request or a call to a call center.

11. A computer program product embodied in a computer readable medium comprising:
computer executable code that receives a booking request for a travel reservation from a user associated with an entity;
computer executable code that determines an online booking rate for users associated with the entity, the online booking rate indicative of a percentage of the users associated with the entity that book online;
computer executable code that determines a cost for booking the travel reservation, the cost based upon the online booking rate for users associated with the entity; and
computer executable code that provides the travel reservation to the user at a price that includes the cost for booking the travel reservation and a cost of the travel reservation.

12. A system comprising:
receiving means for receiving a booking request for a travel reservation from a user associated with an entity;
first computing means for determining an online booking rate for users associated with the entity, the online booking rate indicative of a percentage of the users associated with the entity that book online;
second computing means for determining a cost for booking the travel reservation, the cost based upon the online booking rate for users who are associated with the entity; and
network means for providing the travel reservation to the user at a price that includes the cost for booking the travel reservation and a cost of the travel reservation.

13. A method for booking a travel reservation comprising:
receiving a booking request for a travel reservation from a user, the user associated with an entity;
providing a discount for a booking cost of the booking request relative to travel reservations that are not booked online, the discount determined by a rate of adoption of online booking tools by the entity;
providing the travel reservation to the user at a price that includes the booking cost;
providing a call center for post-booking access by the user; and
establishing a per-minute rate for post-booking access to the call center concerning the travel reservation.

14. The method of claim 13 wherein the call center handles changes and cancellations to the travel reservation booked by the user.

15. The method of claim 13 wherein the call center handles questions about the travel reservation from the user.

16. The method of claim 13 further comprising charging at least one of the user or the entity at the per-minute rate for any post-booking access to the call center concerning the travel reservation that exceeds a maximum number of minutes for a specified period.

17. A system comprising:
a call center that handles calls related to travel reservations;
a booking engine that provide online, self-service booking tools to remote users;
a reservation host;
one or more clients operated by users associated with an entity;
a server connected in a communicating relationship with the call center, the booking engine, and the reservation host through a network, the server further connected in a communicating relationship with the one or more clients, the server providing a booking and fulfillment service that combines the services of the call center, the booking engine, and the reservation host to the clients at a fixed fee per booking, the fixed fee determined according to an adoption rate for booking through the server.

18. A server comprising a network connection to at least one call center, at least one booking engine, and at least one reservation host and a network connection to one or more clients, the clients being operated by users associated with an entity, the server providing a booking and fulfillment service to the one or more clients that combines the services of the call center, the booking engine, and the reservation host for a fixed fee per booking, the fixed fee determined according to an adoption rate for online booking by the users associated with the entity.

19. The server of claim 18 wherein the fixed fee only applies when one or more conditions are met by clients using the server, the conditions including at least one of a maximum number of cancelled reservations, a maximum number of paper tickets issued, a maximum number of exchanges, a maximum number of refunds, and a maximum amount of telephone call time, the fixed fee being recalculated when one or more of the conditions is violated.

20. The system of claim 17 wherein the adoption rate is a percentage of bookings by users associated with the entity that are booked using the server.
